(19) United States
(12) Patent Application Publication
(10) Pub. No.: US 2023/0170608 A1
(43) Pub. Date: Jun. 1, 2023

(54) RADOME COVER DESIGN FOR BEAMFORMING ANTENNA

(71) Applicant: Corning Research & Development Corporation, Corning, NY (US)

(72) Inventors: Cheolbok Kim, Painted Post, NY (US); Stanley Abille Mercado, Santa Clara, CA (US); Anthony Ng'oma, Horseheads, NY (US); Po-Tsung Shih, Painted Post, NY (US)

(21) Appl. No.: 17/684,064

(22) Filed: Mar. 1, 2022

Related U.S. Application Data
(60) Provisional application No. 63/284,134, filed on Nov. 30, 2021.

(51) Int. Cl. H01Q 1/42

(52) U.S. Cl. CPC H01Q 1/42

(57) ABSTRACT

A radome cover design for a beamforming antenna is disclosed. In one aspect, a radome of a polymeric material having two thicknesses with a central thickness optimized for signal transmission at a frequency of interest is provided. Further, the radome is designed to be positioned at a fixed distance from an antenna array so as to provide protection for the antenna array yet still allow for optimal transmission of signals being steered at angles. Such radomes reduce significant signal loss and beam distortion while also being able to be manufactured at commercially reasonable costs.

### CROSS-REFERENCE TO RELATED APPLICATIONS

This application claims the benefit of priority under 35 U.S.C. § 119 of U.S. Provisional Application No. 63/284,134, filed Nov. 30, 2021, the content of which is relied upon and incorporated herein by reference in its entirety.

### BACKGROUND

The technology of the disclosure relates generally to a cover design for a beamforming antenna such as are used by millimeter wave radios.

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences. With the advent of the myriad functions available to such devices, there has been increased pressure to find ways to increase bandwidth of wireless communication infrastructure to support increased demand generated by increased functionality.

The industry has responded to the demand for greater bandwidth by formulating standards for cellular communication at elevated frequencies such as in the tens of gigahertz, corresponding to wavelengths in the millimeter range. As of this writing, the leading example of such standard is the Fifth Generation-New Radio (5G-NR, or just 5G), which operates generally between ten and seventy gigahertz.

One of the challenges of operating in this frequency range and with these wavelengths is signal attenuation. That is, signals at these frequencies are severely attenuated by every-day materials (e.g., drywall, brick, stone, plastic, etc.). One way that attenuation is addressed is through beamforming or beam-steering, which uses electronically-steerable phase array antennas. Such antenna arrays are generally housed in a protective enclosure, which given the risk of attenuation generates design challenges.

### SUMMARY

Aspects disclosed in the detailed description include a radome cover design for a beamforming antenna. Exemplary aspects of the present disclosure provide a radome of a polymeric material having two thicknesses with a central thickness optimized for signal transmission at a frequency of interest. Further, the radome is designed to be positioned at a fixed distance from an antenna array so as to provide protection for the antenna array yet still allow for optimal transmission of signals being steered at angles. Such radomes reduce significant signal loss and beam distortion while also being able to be manufactured at commercially reasonable costs.

In this regard in one aspect, a radome is disclosed. The radome comprises a first component comprising a first thickness. The radome also comprises a peripheral component comprising a second thickness. The peripheral component extends outwardly from the first component and is configured to cover a housing, wherein the first thickness is different than the second thickness.

In another aspect, a radio is disclosed. The radio comprises a housing delimiting an aperture. The radio also comprises a phased array antenna positioned in the aperture. The radio also comprises a radome. The radome comprises a first component configured to cover the aperture and define an air gap between the radome and the phased array antenna. The first component comprises a first thickness. The radome also comprises a peripheral component comprising a second thickness. The peripheral component extends outwardly from the first component and is configured to couple to the housing. The first thickness is different than the second thickness.

### BRIEF DESCRIPTION OF THE DRAWINGS

FIG. 1 is a translucent perspective view of an exemplary radio having a cover over a phased array antenna;

FIG. 2 is a cross-sectional side elevation view of the radio of FIG. 1, highlighting the positioning of the radome relative to the phased array antenna; and

FIGS. 3-7 show, via graphs, results of testing various parameters of the radome at 28 gigahertz (Ghz).

### DETAILED DESCRIPTION

Aspects disclosed in the detailed description include a radome cover design for a beamforming antenna. Exemplary aspects of the present disclosure provide a radome of a polymeric material having two thicknesses with a central thickness optimized for signal transmission at a frequency of interest. Further, the radome is designed to be positioned at a fixed distance from an antenna array so as to provide protection for the antenna array yet still allow for optimal transmission of signals being steered at angles. Such radomes reduce significant signal loss and beam distortion while also being able to be manufactured at commercially reasonable costs.

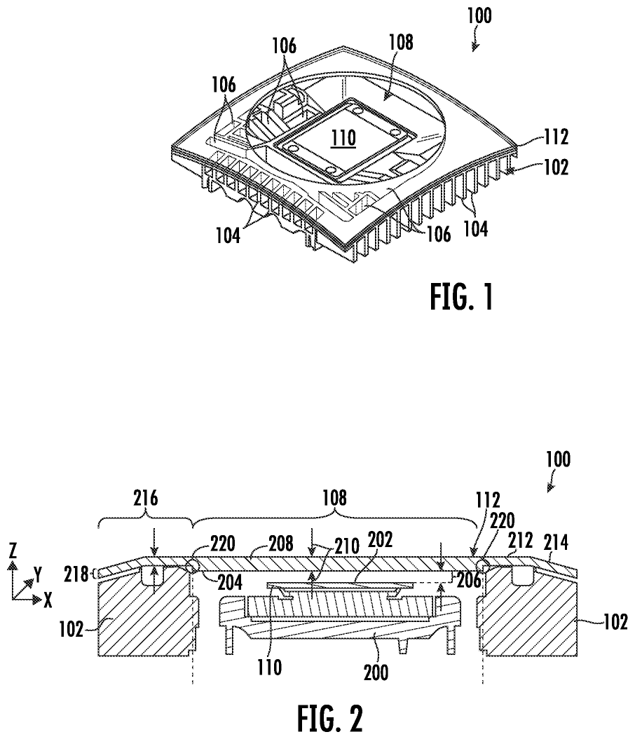

In this regard, FIG. 1 is a perspective view of a radio 100. In an exemplary aspect, the radio 100 may be a Fifth Generation-New Radio (5G-NR or just 5G) millimeter wave (mmWave) radio. The radio 100 may include a housing 102 that includes fins 104 to assist in heat dissipation. The housing 102 may further include cavities 106 that are configured to hold electronic circuitry (not shown) such as a baseband processor, a transmission chain with power amplifiers, and a receive chain with low noise amplifiers as is well understood. The housing 102 may delimit a central aperture 108. A phased array antenna 110 may be positioned such that signals emitted by the phased array antenna 110 may pass through the aperture 108 and signals transmitted to the radio 100 may likewise pass through the aperture 108. A cover or radome 112 may be affixed to the housing 102 through mechanical means (not shown but could be, for example, bolts, screws, rivets, nails, adhesive, or the like). The radome 112 is designed to cover the aperture 108 and help protect the phased array antenna 110.

FIG. 2 provides a cross-sectional view of the radio 100 in which the housing 102 with the radome 112 attached thereto may be more readily seen. As noted, the housing 102 may delimit the aperture 108. The phased array antenna 110 may be positioned within the housing 102. In particular, the phased array antenna 110 may be positioned on a support structure 200. A front face 202 of the phase array antenna 110 may be spaced from a back face 204 of the radome 112 by an air gap 206.

In an exemplary aspect, the radome 112 has a first component 208 that is generally planar in an x-y plane and has a first thickness 210 that covers the aperture 108. Further, the radome 112 has a second component 212 that is generally coplanar with the first component 208 and a third component 214 that is angled down and away (along a z-axis) from the second component 212. Collectively the second component 212 and the third component 214 form a peripheral component 216. The peripheral component 216 has a second thickness 218, different from the first thickness 210, and in a specifically contemplated aspect, the second thickness 218 is less than the first thickness 210. A shoulder 220 may be formed where the first component 208 and the second component 212 join. The dimension of the shoulder 220 may correspond to the difference between the first thickness 210 and the second thickness 218. Likewise, the shoulder 220 may be configured to abut the housing 102.

In an exemplary aspect, the radome 112 is made from a polymeric material and may be injection molded either as a single piece in a single injection, a single piece in two injections, or two pieces secured to one another. For the two-injection process, a first injection creates a piece having the second thickness 218 throughout, and a second injection adds thickness to the first component 208 to achieve the first thickness 210. In an exemplary aspect, the polymeric material may be a polycarbonate/Acrylonitrile Butadiene Styrene (PC/ABS) material such as CYCOLOY™ Resin C2950, sold by SABIC having a sales office at 44 Normar Road, Cobourg, Ontario Canada K9A 4L7. As best understood, the dielectric constant of this material is 2.68.

As noted, the radome 112 and particularly the first component 208 may be sized in the x-y plane to correspond to the aperture 108 (e.g., a circle with a diameter of approximately 120 millimeters (mm)) with the peripheral component 216 sized to cover the housing 102. In an exemplary aspect, if the radome 112 is going to be used with a phased array antenna 110 that operates at 28 gigahertz (GHz), the first thickness 210 may be approximately 3.5 mm and the second thickness 218 may be approximately 2.2 mm. Approximately as used herein is within one percent (1%). In contrast, if the radome 112 is going to be used with a phased array antenna 110 that operates at 39 GHz, the air gap 206 may be approximately 4.3 mm, the first thickness 210 may be approximately 2.5 mm, and the second thickness 218 may be approximately 2.2 mm.

The dimension of the second thickness 218 is chosen so as to have sufficient structural integrity to protect the housing 102 and the phased array antenna 110 while also being thinner than the first component 208 so as to reduce material costs and allow for easy manufacturing.

At first inspection, the numbers for the dimensions set forth above may seem counter-intuitive because, based on Fabry-Perot interferometer theory, the minimum signal reflection at the surface of a dielectric cover (e.g., the back face 204) is achieved when the dielectric cover thickness equals an integer number (N) times half the equivalent wavelength of the signal (i.e., t=Nλ/(2\sqrt{εr}), where t is the dielectric thickness, λ, is the wavelength of the signal, and εr is the dielectric constant of the material). Accordingly, at 28 GHz, the wavelength in air is 10.7 mm and the wavelength in the radome 112 is 6.5 mm. Thus, one would expect an optimized air gap and first thickness 210 to be about 5.3 mm and 3.3 mm, respectively. However, the presence of metallic and non-metallic structures, as well as the fact that the beams are radiated along a variety of axes as a function of the beam steering changes the performance from the ideal Fabry-Perot calculations.

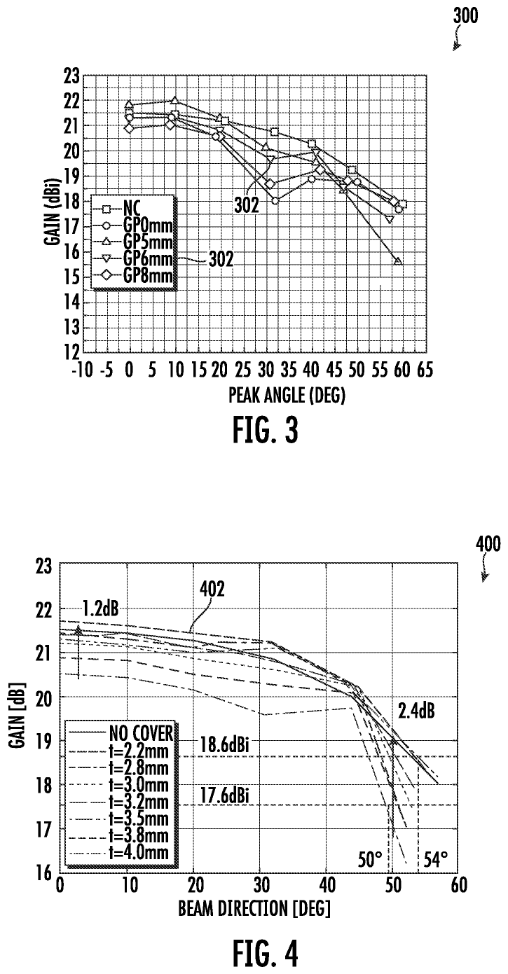

Through the use of simulation software, particularly ANSYS HFSS, a variety of simulations confirm the values presented above provide the best compromise. The results of the simulations are provided in FIGS. 3-7.

In this regard, FIG. 3 illustrates a graph 300 showing the gain versus peak angle and the impact of varying the air gap 206 at 28 GHz and a first thickness 210 of 2.2 mm. Across the angles of interest (e.g., 0 to about 40 degrees), the line 302 corresponding to an air gap 206 of 6 mm is overall the best compromise. Thus, an air gap 206 of 6 mm reduces the loss induced by the radome 112 for both boresight beams and beams at high angles.

FIG. 4 illustrates a graph 400 showing the gain versus the beam direction and the impact of varying the first thickness 210 at 28 GHz. Results show that a thickness of 3.5 mm (line 402) shows significant advantage over other thicknesses.

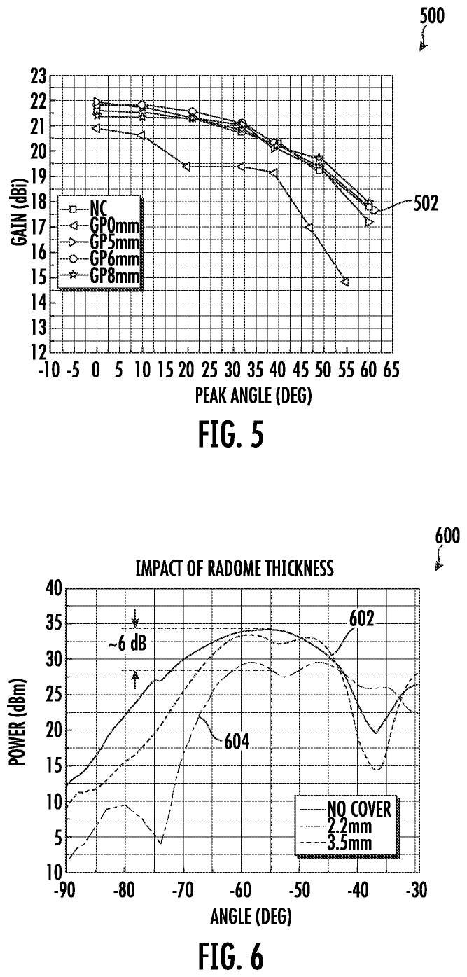

FIG. 5 illustrates a graph 500 showing the gain versus peak angle and the impact of varying the air gap 206 at 28 GHz and a first thickness 210 of 3.5 mm. Across the angles of interest (e.g., 0 to about 40 degrees), the line 502 corresponding to an air gap 206 of 6 mm is overall the best compromise. Thus, an air gap 206 of 6 mm reduces the loss induced by the radome 112 for both boresight beams and beams at high angles. Compared with graph 300, it is clear that the optimal air gap 206 for a 3.5 mm thick radome and a 2.2 mm thick radome is still 6 mm. This result is expected because the optimal air gap 206 should be a function of the cavity material and not the radome material or thickness.

FIG. 6 shows a graph 600 showing power versus angle and the impact of the first thickness 210. Specifically, the differences between no cover, 2.2 mm, and 3.5 mm are illustrated. The line 602 corresponding to 3.5 mm shows significantly reduced loss and beam distortion relative to the line 604 corresponding to 2.2 mm.

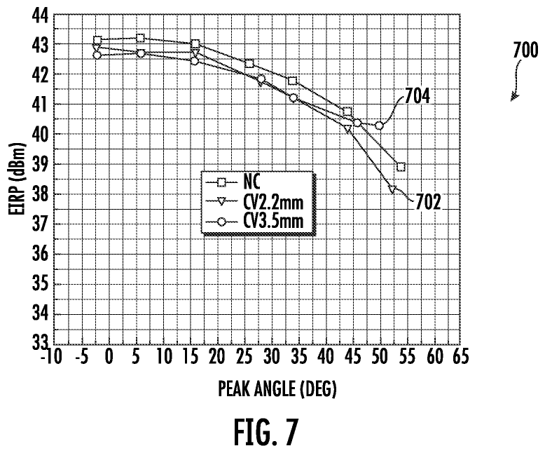

FIG. 7 shows a graph 700 showing the measured effective isotropic radiated power (EIRP) versus peak angle showing the performance difference between radomes having a first thickness 210 of 2.2 mm (line 702) versus 3.5 mm (line 704) at 28 GHz and an air gap 206 of 6 mm. The 3.5 mm thick radome 112 exhibits high signal transmission at the high-angle beams (>30 degrees).

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modification combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A radome comprising:
a first component comprising a first thickness; and
a peripheral component comprising a second thickness, the peripheral component extending outwardly from the first component and configured to cover a housing, wherein the first thickness is different than the second thickness.

2. The radome of claim 1, wherein the first thickness comprises approximately 3.5 millimeters (mm).

3. The radome of claim 1, wherein the first component is generally planar.

4. The radome of claim 3, wherein the peripheral component comprises a second component coplanar with the first component and a third component that extends outwardly and down from the second component.

5. The radome of claim 1, wherein the second thickness comprises approximately 2.2 millimeters (mm).

6. The radome of claim 1, wherein the first component comprises a polymeric material.

7. The radome of claim 1, wherein the first component comprises a dielectric constant of 2.68.

8. The radome of claim 1, wherein the first thickness comprises approximately 2.5 millimeters (mm).

9. The radome of claim 1, wherein the first component comprises a circular planar structure.

10. A radio comprising:
a housing delimiting an aperture;
a phased array antenna positioned in the aperture; and
a radome comprising:
a first component configured to cover the aperture and define an air gap between the radome and the phased array antenna, the first component comprising a first thickness; and
a peripheral component comprising a second thickness, the peripheral component extending outwardly from the first component and configured to couple to the housing, wherein the first thickness is different than the second thickness.

11. The radio of claim 10, wherein the housing comprises one or more cavities configured to hold electronic circuitry.

12. The radio of claim 10, wherein the first thickness comprises approximately 3.5 millimeters (mm).

13. The radio of claim 10, wherein the first component is generally planar.

14. The radio of claim 13, wherein the peripheral component comprises a second component coplanar with the first component and a third component that extends outwardly and down from the second component.

15. The radio of claim 10, wherein the second thickness comprises approximately 2.2 millimeters (mm).

16. The radio of claim 10, wherein the first component comprises a polymeric material.

17. The radio of claim 10, wherein the first component comprises a dielectric constant of 2.68.

18. The radio of claim 10, wherein the first thickness comprises approximately 2.5 millimeters (mm).

19. The radio of claim 10, wherein the first component comprises a circular planar structure.

20. The radio of claim 10, wherein the air gap is approximately 6 millimeters (mm).
